(19) United States
(12) Patent Application Publication
(10) Pub. No.: US 2015/0261413 A1
(43) Pub. Date: Sep. 17, 2015

(54) SYSTEM AND METHODS OF ACTIVATING AN INTERNET RELATED ACTIVITY USING A DATA FIELD IN A BROWSER WINDOW

(71) Applicant: Yehuda Raiter, Tel Aviv (IL)

(72) Inventor: Yehuda Raiter, Tel Aviv (IL)

(73) Assignee: TECNOLOGY STARWIZ LTD, Tel Aviv (IL)

(21) Appl. No.: 14/205,420

(22) Filed: Mar. 12, 2014

(51) Int. Cl. G06F 3/0484; G06F 3/0481

(52) U.S. Cl. CPC G06F 3/04842; G06F 3/04817

(57) ABSTRACT

A method of activating an internet related activity using a computerized apparatus operatively connected to the Internet, the method facilitating a user using a web browser with a browser window, having a data field for entering data, to use the data field to perform one or more selected internet related activity using the entered data. The method includes providing selecting icons in proximity to the data field, wherein an activation module is associated with each of the selecting icons, entering desired data into the data field by the user, selecting one or more of the selecting icons by the user, and activating the respective activation module associated with each of the selected icons.

### FIELD OF THE INVENTION

The present invention relates to WWW page retrieval and, more particularly, the present invention relates to a system and methods of using the URL addressing field for activities that may not be related to URL webpage addressing, such as posting a status into a social network page of the browsing user.

### BACKGROUND OF THE INVENTION

The World Wide Web (WWW) is a set of protocols that allow a user to browse through pages of information on his/her computerized device downloaded from a host computer, typically using a program application called a browser. Both computers are operatively interconnected by a network called an internet network. The usual mode of operation includes opening a browser, entering a Uniform Resource Locator (URL), and viewing the page fetched by the browser form the host computer, which is typically mapped to one or more domain names.

URL syntax is described in RFC 1630 (“Uniform Resource Identifiers in WWW”). The URL syntax relies heavily on the domain name space, as defined in RFCs 1034 (“Domain Names—Concepts and Facilities”), 1035 (“Domain Names implementation and Specification”) and 883 (“Domain names—Implementation and Specification”).

U.S. Pat. No. 8,661,094 given to Net-Express Ltd., describes a method of performing a web search by typing text into the URL addressing field of the browser. However, it is not possible to date to use the URL addressing field of a browser for other activities, which activities may not be related to URL webpage addressing.

There is a need and it would be advantageous to be able to use the URL addressing field of a browser for activities that may not be related to URL webpage addressing, such as posting a status into a social network page of the browsing user.

The term “status posting” as used herein refers personal related data of a particular user that he/she select to post in his/her personal page of a selected social network such as Facebook, Twitter, Myspace, Whatsup, Linkedin, Instagram, Google+, etc. The posted data may include textual data, links, images, video and vocal data. Entering data into a data field of a chat, may also be used for status posting.

### SUMMARY OF THE INVENTION

By way of introduction, the principal intentions of the present invention include providing a system and methods for using the URL addressing field of a browser, as well as a search field of a search engine such as Google and other input text fields, for activities that may not be related to URL webpage addressing, such as posting a status into a social network page of the browsing user.

According to the teachings of the present invention, there is provided a method of activating an internet related activity using a computerized apparatus operatively connected to the Internet, the method facilitating a user using a web browser with a browser window, having a data field for entering data, to use the data field to perform one or more selected internet related activity using the entered data.

The method includes providing selecting icons in proximity to the data field, wherein an activation module is associated with each of the selecting icons, entering desired data into the data field by the user, selecting one or more of the selecting icons by the user, and activating the respective activation module associated with each of the selected icons.

Optionally, the entered data is selected from a group of input data including textual data, links, image data, video data and vocal data.

Optionally, the selecting icons are selected from a group of selecting data-items including icons, symbols, check-boxes, banners, and marks.

Optionally, the activation modules are selected from a group of selecting data-items including a WWW page retrieving module, a search engine, a status posting module associated with one or more social networks.

Optionally, the activation module is a status posting module for posting the entered data in the selected one or more social networks.

Optionally, the activation module is a search engine for conducting a web search on the entered data.

Optionally, a first of the activation modules is a status posting module for posting the entered data in the selected one or more social networks, wherein a second of the activation modules is a search engine for conducting a web search on the entered data, and wherein the first and second activation modules are activated substantially simultaneously.

Optionally, for activating an internet related activity using a computerized apparatus operatively connected to the Internet, the method facilitates a user using a web browser with a browser window, having a data field for entering data, to use the data field to perform one or more selected internet related activity using the entered data.

### BRIEF DESCRIPTION OF THE DRAWINGS

The present invention will become fully understood from the detailed description given herein below and the accompanying drawings, which are given by way of illustration and example only and thus not limitative of the present invention, and wherein:

FIG. 1 is a general schematic block diagram illustration of the components of a multi-use-data-field system, according to an embodiment of the present invention.

FIG. 2 shows a schematic flowchart diagram of an example multi-use-data-field method entering status date in an input URL-addressing text field of Google-search field, according to an embodiment of the present invention, wherein the entered status data is used to automatically update the social network page of the browsing user.

FIG. 3 shows a schematic flowchart diagram of an example multi-use-data-field method entering selected date in an input URL-addressing text field, or a Google-search field, according to an embodiment of the present invention, wherein the entered data is automatically processed.

FIG. 4 is a general schematic block diagram illustration of the components of a variation of the multi-use-data-field system shown in FIG. 1.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein;

rather, these embodiments are provided, so that this disclosure will be thorough and complete, and will fully convey the scope of the invention to those skilled in the art.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

Methods of the present invention may be implemented by performing or completing manually, automatically, or a combination thereof, selected steps or tasks. The order of performing some methods step may vary. The descriptions, examples, methods and materials presented in the claims and the specification are not to be construed as limiting but rather as illustrative only.

Meanings of technical and scientific terms used herein are to be commonly understood as to which the invention belongs, unless otherwise defined. The present invention can be implemented in the testing or practice with methods and materials equivalent or similar to those described herein.

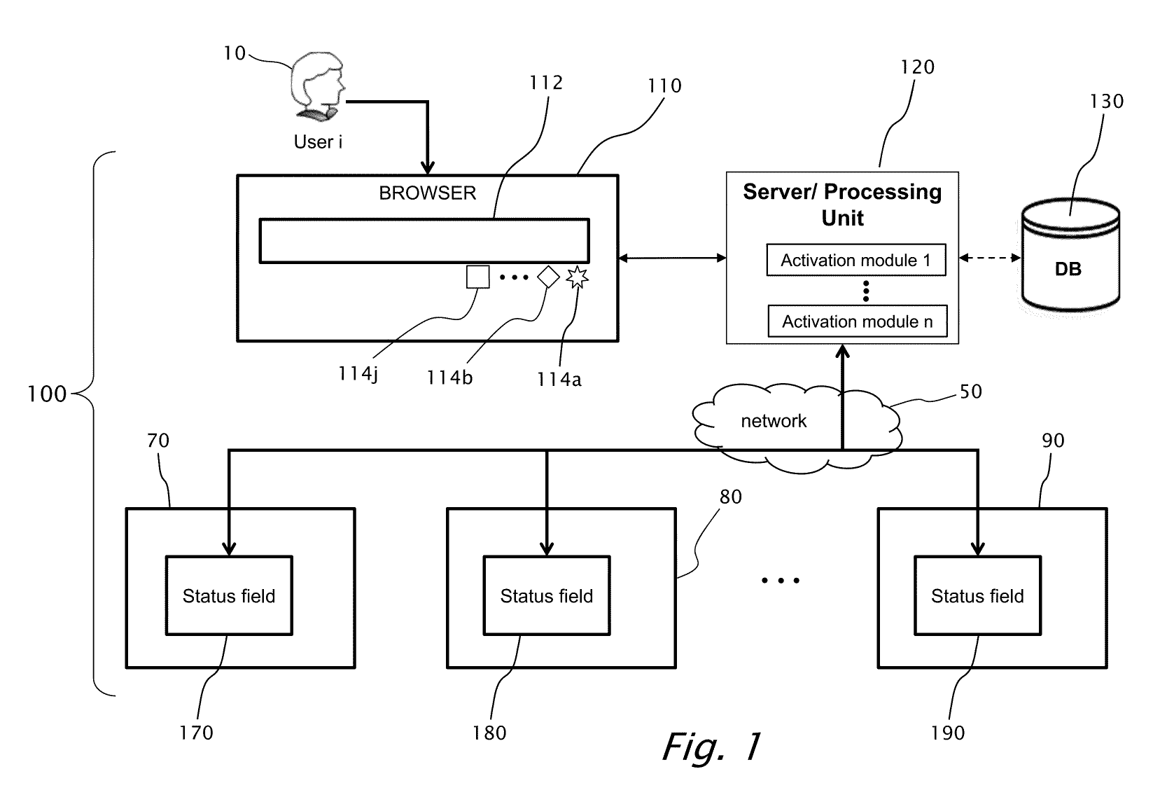

Reference is now made to the drawings. FIG. 1 is a general schematic block diagram illustration of the components of a multi-use-data-field system 100, according to an embodiment of the present invention. Multi-use-data-field system 100 includes a server 120 for processing the data entered into a designated data field.

Server 120 of multi-use-data-field system 100 may be a remote server, an in-house server or a local computer. The present invention will be described, by way of example, with no limitations, in terms of the server of multi-use-data-field system 100 being a remote server.

Server 120 may be operatively coupled with a database 130 for collecting data about users, their history, their related data and/or any other data.

Server 120 collects the personal data of a user 10ᵢ that wishes to use multi-use-data-field system 100, either by a login procedure, via a cookie and/or by any other commonly used method.

In some embodiments of the present invention, a designated data field 112 in a webpage of a browser 110, is accompanied by one or more selectable icons/symbols/check-boxes/banners/marks/data-items (referred to herein as “icons”) 114. By selecting particular icon 114ⱼ of his choice, user 10ᵢ indicates to server 120 the type of data he/she is entering into data field 112. Icon 114ⱼ may be that of URL, a search field such as Google, a status field of a social network such as Facebook, Twitter, Myspace, Whatsup, Linkedin, Instagram, Google+, etc., a combination of all social networks that user 10ᵢ is a member of, or any other webpage with a particularly designated data field. Icon 114ⱼ may also combine a search and status posting, simultaneously. Icon 114ⱼ may also facilitate activating a microphone for entering vocal data. In the example shown in FIG. 1, server 120 may be operatively connected, over an internet network 50, to a first social network 70, a second social network 80 and a third social network 90. Server 120 may obtain the entered data via API, XML, or by any other method known in the art.

Optionally, data field 112 is flexible in dimensions. Optionally, the dimensions of data field 112 are adaptive to the size of the data being input by user 10ₖ.

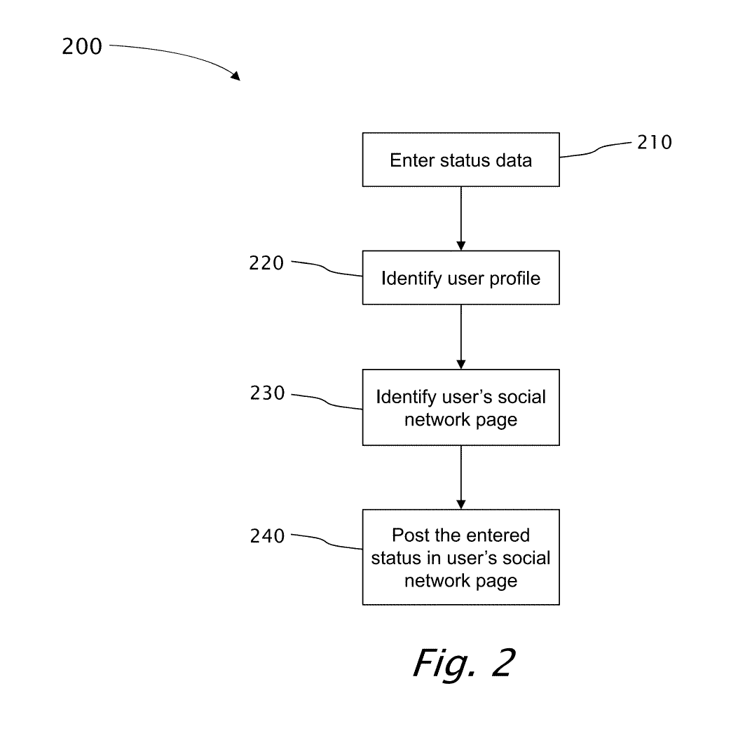

Reference is now made to FIG. 2, showing a schematic flowchart diagram of an example multi-use-data-field method 200 entering status date in an input URL-addressing text field, or a Google-search field, according to an embodiment of the present invention, wherein the entered status data is used to automatically update the selected social network page of the browsing user 10ₖ. Multi-use-data-field method 200 includes, with no limitations, the following steps:

Step 210: entering status data.

If not a default, user 10ᵢ selects one or more social networks of his/her choice and enters the status data in data field 112.

Step 220: identifying the user's profile. Server 120 identifies the profile of user 10ᵢ to thereby identify his/her one or more selected social network pages.
Step 230: identifying the user's social network page.

Having identified user 10ₖ, server 120 identify his/her one or more selected social network pages.

Step 240: posting the entered status in the user's social network page.

Server 120 posts the entered status in a designated field of user's 10ᵢ one or more selected social network pages.

(end of product-recognition method 200)

To use multi-use-data-field system 100, a user 10ᵢ may select a target application(s) using icons 114, enter the text of his/her choice and activate the field.

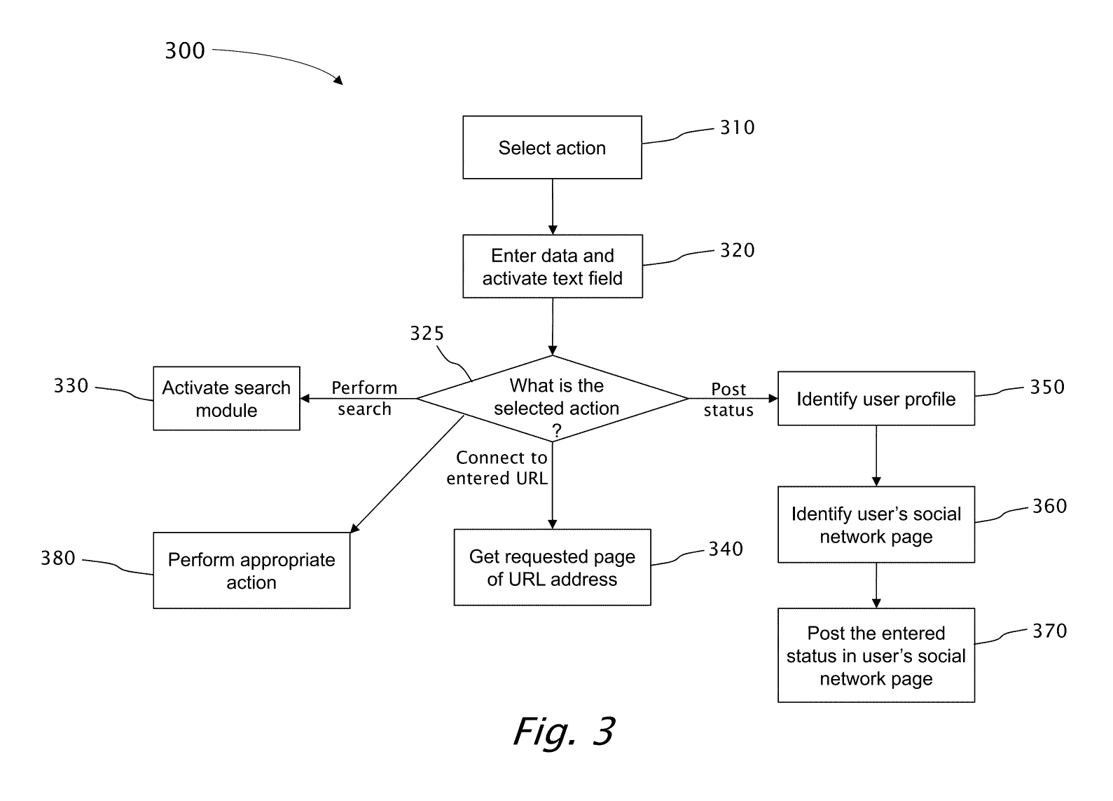

Reference is now made to FIG. 3, showing a schematic flowchart diagram of another example multi-use-data-field method 300 entering status date in an input URL-addressing text field, or a Google-search field, according to an embodiment of the present invention, wherein the entered status data is used to automatically update the selected social network page of the browsing user 10ₖ. Multi-use-data-field method 300 includes, with no limitations, the following steps:

Step 310: selecting action.

User 10ᵢ selects a target application(s) using icons 114.

Step 320: enter data and activate text field.

User 10ᵢ enters the text (or image, if allowed) of his/her choice, suited for use by the selected target application(s), and activate the field.

Step 325: checking what is the required next action.

Server 120 checks what the required next action is:

If the required next action is connecting to entered URL, go to step 340; else if the required next action is connecting to entered URL, go to step 350; else go to step 380.

Step 330: activating a search module.

Since the required next action is performing a search, server 120 activates a search module.

Exit.

Step 340: getting the requested page of URL address.

Server 120 obtains the requested page of the entered URL address.

Exit.

Step 350: identifying the user's profile.

Server 120 identifies the profile of user 10ᵢ to thereby identify his/her one or more selected social network pages.

Step 360: identifying the user's social network page.

Having identified user 10ₖ, server 120 identify his/her one or more selected social network pages.

Step 370: posting the entered status in the user's social network page.

Server 120 posts the entered status in a designated field of user's 10ᵢ one or more selected social network pages.

Exit.

Step 380: performing the appropriate action.

Server 120 activates the appropriate application(s) corresponding to icon 114 that was selected in step 310.

(end of event-participation method 300)

A user 10ᵢ may select a target application(s) using icons 114, wherein the text (or image, if allowed) of his/her choice is entered in a non-URL-address field. For example, the non-URL-address field is a field in a page of a social network, designated for entering a status.

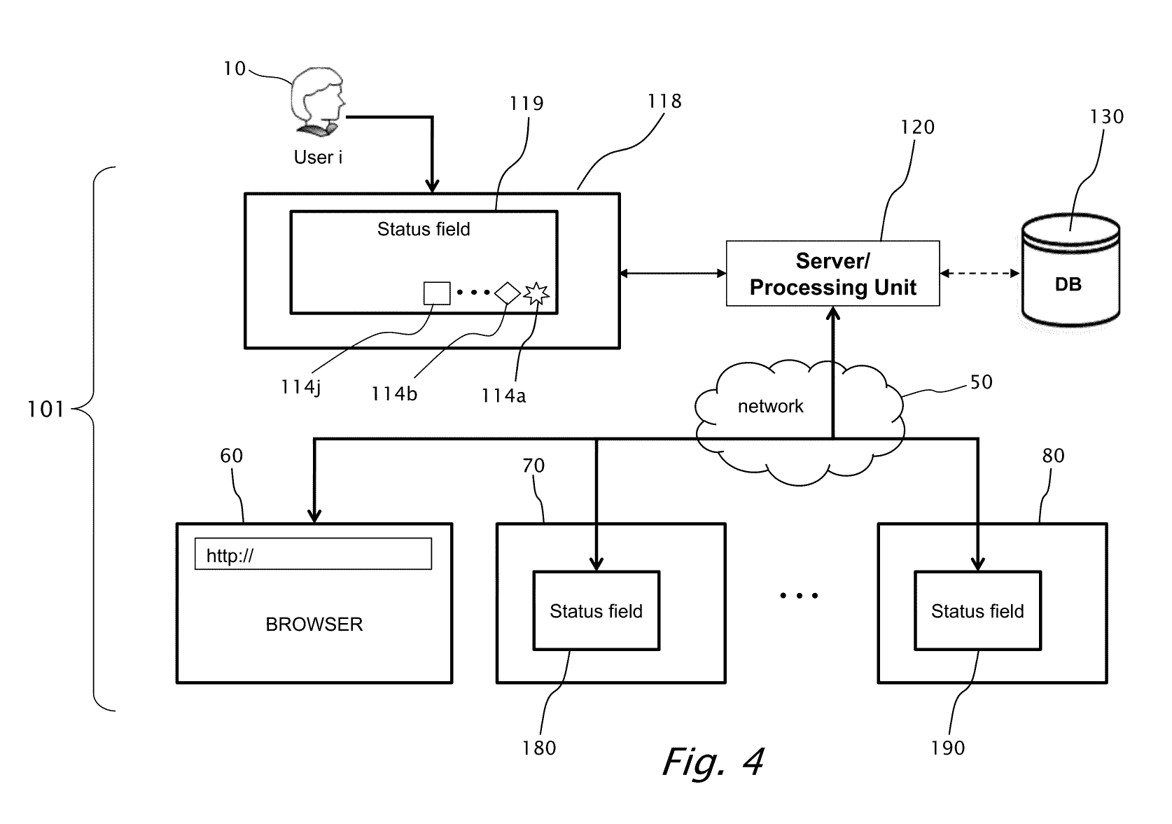

Reference is now also made to FIG. 4, showing a general schematic block diagram illustration of the components of a of a multi-use-data-field system 101, according to some embodiments of the present invention, multi-use-data-field system 101 being a variation of multi-use-data-field system 100.

In the example shown in FIG. 4, a user 10ᵢ may select a target application(s) using icons 114, wherein the data of his/her choice is entered into a status field 119 of a page 118 of a particular social network.

Server 120 then activate the appropriate application(s) is indicated by user 10ᵢ by selecting an icon 114. Icon 114ⱼ may be that of URL, a search field such as Google, a status field of a social network such as Facebook, Twitter, Linkedin, Instagram, Google+, etc., a combination of all other social networks that user 10ᵢ is a member of, or any other webpage with a particularly designated data field. In the example shown in FIG. 1, server 120 may be operatively connected, over an internet network 50, to a first social network 70, to a second social network 80 and to a bowser 60.

Although the present invention has been described with reference to the preferred embodiment and examples thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the following claims.

What is claimed is:

1. A method of activating an internet related activity using a computerized apparatus operatively connected to the Internet, the method facilitating a user using a web browser with a browser window, having a data field for entering data, to use said data field to perform one or more selected internet related activity using said entered data, the method comprising the steps of:
a) providing selecting icons in proximity to said data field, wherein an activation module is associated with each of said selecting icons;
b) entering desired data into said data field by the user;
c) selecting one or more of said selecting icons by the user; and
d) activating the respective activation module associated with each of said selected icons.

2. The method as in claim 1, wherein said entered data is selected from a group of input data including textual data, links, image data, video data and vocal data.

3. The method as in claim 1, wherein said selecting icons are selected from a group of selecting data-items including icons, symbols, check-boxes, banners, and marks.

4. The method as in claim 1, wherein said activation modules are selected from a group of selecting data-items including a WWW page retrieving module, a search engine, a status posting module associated with one or more social networks.

5. The method as in claim 4, wherein said activation module is a status posting module for posting said entered data in the selected one or more social networks.

6. The method as in claim 4, wherein said activation module is a search engine for conducting a web search on said entered data.

7. The method as in claim 4, wherein a first of said activation modules is a status posting module for posting said entered data in the selected one or more social networks, wherein a second of said activation modules is a search engine for conducting a web search on said entered data, and wherein said first and second activation modules are activated substantially simultaneously.

8. A system for performing a method as in claim 1, for activating an internet related activity using a computerized apparatus operatively connected to the Internet, the method facilitating a user using a web browser with a browser window, having a data field for entering data, to use said data field to perform one or more selected internet related activity using said entered data.
